(19) United States
(12) Patent Application Publication
(10) Pub. No.: US 2008/0030074 A1
(43) Pub. Date: Feb. 7, 2008

(54) Automatic reacting for all sorts of devices

(76) Inventor: Henri Duong, Alhambra, CA (US)

Correspondence Address: Henri Duong, 316 1/2 E Glendon Way, Alhambra, CA, 91801, US

(21) Appl. No.: 11/499,092

(22) Filed: Aug. 4, 2006

(51) Int. Cl. B60T 8/32

(52) U.S. Cl. 303/193

(57) ABSTRACT

Automatic reacting is to react automatically or in a better manner to replace manual operation by thermostat, video camera, radar, all kinds of sensors including reacting proximate sensor, touch sensor, speedometer, motor, switch, timer and/or any other equivalents for making useful devices.

### CROSS-REFERENCE TO RELATED APPLICATION

Disclosure Document Deposit Request; Document No:

| | |
|---|---|
| 541422 date Nov. 04, 2003 | 563276 date Oct. 21, 2004 |
| 539639 date Oct. 08, 2003 | 540681 date Oct. 24, 2003 |

patent application Ser. No. 10/725,226 filing date: Dec. 1, 2003 Art Unit no. 3683

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

Automatic reacting is to react automatically or in better manner replacing usual manual operation by devices; thermostat, video camera, radar, all sorts of sensors including reacting proximate sensor, touch sensor, speedometer, motor, switch, timer or any other equivalents:

Automatic reacting system is for cutting off gas automatically flame of gas heating, gas stove, etc and for spraying water against fire in houses, buildings, airplanes, all motor & engine vehicles both reacted by thermostat(s), sensor, detector, or similar equivalents to save human lives in case of accident.

Automatic changing oil device, motor rotating jack, auto pointing transmission, automatic accelerator, automatic emergency (hand) brake are equipped with motors to function pressing on button switches or sensors in place of manual operation.

Automatic reacting seat belt in vehicle, speedometer sounding beyond speed limit, automatic timer for stove all are of security devices for users. Automatic reacting proximate sensors or touch sensors as keys, buttons are used with or without motor for accelerating speed to be more convenient.

Automatic processing is for operation of transmission, reception, copying, scanning and printing on both side data of document and paper in all facsimile machine, copier, scanner and printer in place of single side doing.

### BRIEF SUMMARY OF THE INVENTION

Advantages of the invention are:

for averting housing & material damages caused by fire, gas explosion to save human lives by automatic reacting device

for saving time by motor with button switch in place of manual operation

for automatically changing transmission, locking emergency brake, using accelerator

for sounding to fasten seat belt(s) in vehicle for safety

for saving time, more convenient by using sensors in place of buttons

for saving time processing both side data in facsimile machine, copier, scanner, printer reducing paper half quantities less than usual

The invention composes of process of making the invention, energy of all kinds for functioning, automatic reacting devices, video camera, sensors, switches Duo-A1: automatic cut off device, thermostat, sensor, motor, gas valve, pipe, gas button Duo-A1a: automatic reacting switching, thermostat, switch, installation for air conditioner Duo-A2: automatic motor rotating valve, motor, central valve, pipes, spraying outlets, timer & spraying powder device, central faucet, container, motor, outlet disk, pipes, outlets, sensor Duo-A3: automatic changing oil device, motor, switch, hidden sensor, engine oil bolt of inner pipe in holes with gear head, gear of motor axis, button switch Duo-A3a motor rotating jack, motor, gear head bolt of a jack, gear of motor axis, jack bolt, motor, drill of air pumping Duo-A4: anti-fire device, thermostat, sensor, motor, valve, faucets, water pipes, fire extinguisher, anti-fire chemicals, sprays, rotating spray devices, fire alarm Duo-A5: auto pointing transmission, motor, transmission handle, button switches, mini-motor, round wheel, handle button, rewind spring, spring lock, metal sheet with holes, switches, lamp, sensor Duo-A5a automatic accelerator for non automatic transmission, switch or sensor, button switches, speedometer, clutch pedal axis, motor, clutch, spring oil seal(s), mini motor, carburetor bracket axis, cable, bracket, spring, cable bolt, rewind spring, (hidden) transmission handle, switches, spring lock, metal sheet with holes, lamp, radar, sensor Duo-A6: emergency brake, motor, wheel, cable, button switch, sensor, lock device, metal sheet with holes, rewind spring, mini-motor Duo-A7: automatic reacting seat belt, sensor, seat belt, device, sonorous signal lamp, recorded message, screen, button switch, seat belt lock(s) Duo-A8: automatic accelerator, switch, sensor, mini motor, carburetor bracket axis, cable, bracket, spring, cable bolt, rewind spring, radars, speedometer, motor, bracket, device, recorded message, speedometer pointer, indicator front/rear surface Duo-A8a automatic rotating of radar or sensor in automatic braking device, radar(s), gear, axis, bearings, gear of steering wheel, speedometer, automatic accelerator device, automatic braking device Duo-A9: automatic showing of horizontal level, horizontal level indicators Duo-A10: automatic proximate reacting sensor, touch sensor, mini-motor, round wheel, lock wheel, rewind springs Duo-A11: automatic reacting proximate sensors, touch sensors as keys, sensors in keyboard of computer PC, sensors in keyboard of laptop, sensors in keyboard of word-processor, sensors in keyboard of typewriter, sensors in keyboard of piano Duo-A12: automatic reacting proximate sensors, touch sensors as buttons in appliances, calculator sensor buttons, telephone sensor buttons, facsimile machine sensor buttons, copier sensor buttons, microwave sensor buttons, piano sensor keys, sensor buttons in music instruments, sensor buttons in game boy Duo-A13: automatic proximate reacting sensor, touch reacting sensor as buttons, mini-motor, oval wheel, camera, video camera, battery Duo-A14: automatic reacting proximate sensor, bell, electric lift, electric belting conveyor, sensors, mini-motor(s), installation Duo-A15: manual rotating stove timer, electronic numbering timer, installation to stove of gas, stove of electricity Duo-A16: auto-moving cover at separate unit, (ball) rail in groove part of cooker body Duo-A17: facsimile machines, copiers, scanners, printers, scanning units, printing units, extra rollers, extra fans, sensor buttons, electronic setting to function and appliances, substitutes, installation, necessary parts, accessories.

### BRIEF DESCRIPTION OF THE DRAWINGS

FIG. 1: Duo-A1 Automatic reacting by thermostat, motor

FIG. 1: Duo-A2a Spraying powder device

FIG. 2: Duo-A3 Automatic changing oil device

FIG. 3: Duo-A4 Anti-fire housing, transportations

FIG. 4: Duo-A5 Auto-pointing transmission

FIG. 4: Duo-A5a Automatic accelerator for non automatic transmission

FIG. 5: Duo-A6 Automatic emergency (hand) brake

FIG. 6: Duo-A7 Automatic reacting seat belt in vehicle

FIG. 7: Duo-A8 Automatic accelerator

FIG. 7: Duo-A8a Automatic rotating of radar or sensor in automatic braking device

FIG. 8: Duo-A10 Automatic reacting by sensor opening doors of appliances

FIG. 9: Duo-A16 Auto-moving cover

FIG. 10: Duo-A17 Structure of processing document & paper on both sides

FIG. 11: Process of printing paper on both sides

### DETAILED DESCRIPTION OF THE INVENTION

Automatic reacting by thermostat, video camera, radar, all kinds of sensors including reacting proximate sensor, touch sensor, sensor keys, sensor buttons, speedometer, motor, switch, timer and/or any other equivalents, using energy of all kinds for functioning:

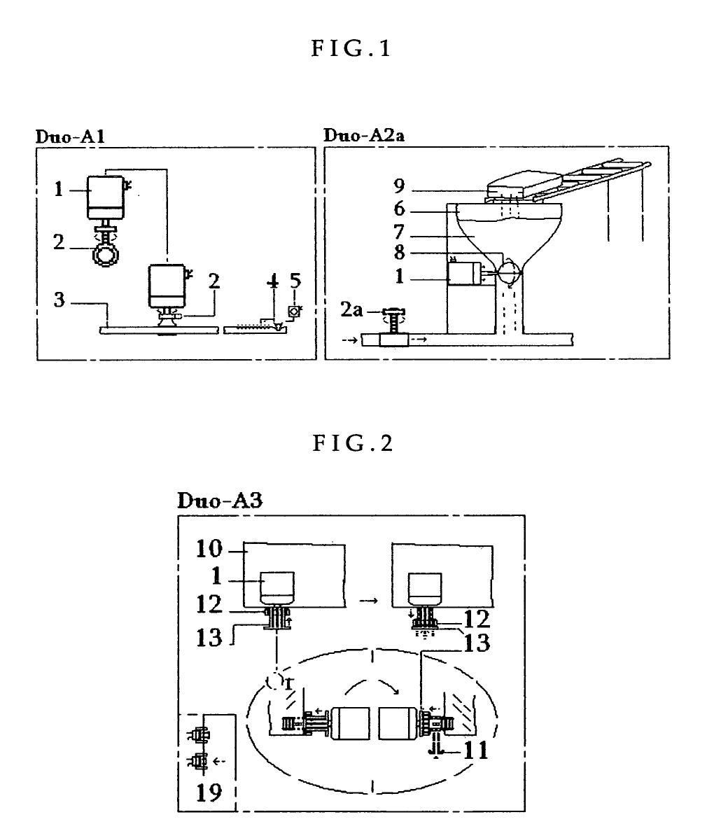

FIG. 1; Duo-A1 Automatic reacting by thermostat, motor, valve for cutting off gas: detecting function on cooling; thermostat 5, sensor or equivalent is connected and installed nearby flame of gas heating, gas stove, etc connected motor 1 turning gas valve 2 of pipe 3 to cut-off position based detected result of thermostat 5 to stop gas 4 spreading dangerously whenever gas flame is blown off by accident, system functions while we rotate gas button in use.

Duo-A1a Automatic reacting by thermostat switching on or off for air conditioner: thermostat is connected and installed either in air conditioner or in air conditioning inside area to switch air conditioner off whenever temperature is high or to switch it on whenever temperature drops below based desirable temperature being switched, which includes installation of thermostat in air conditioner for vehicle, all transportations to that function saving energy.

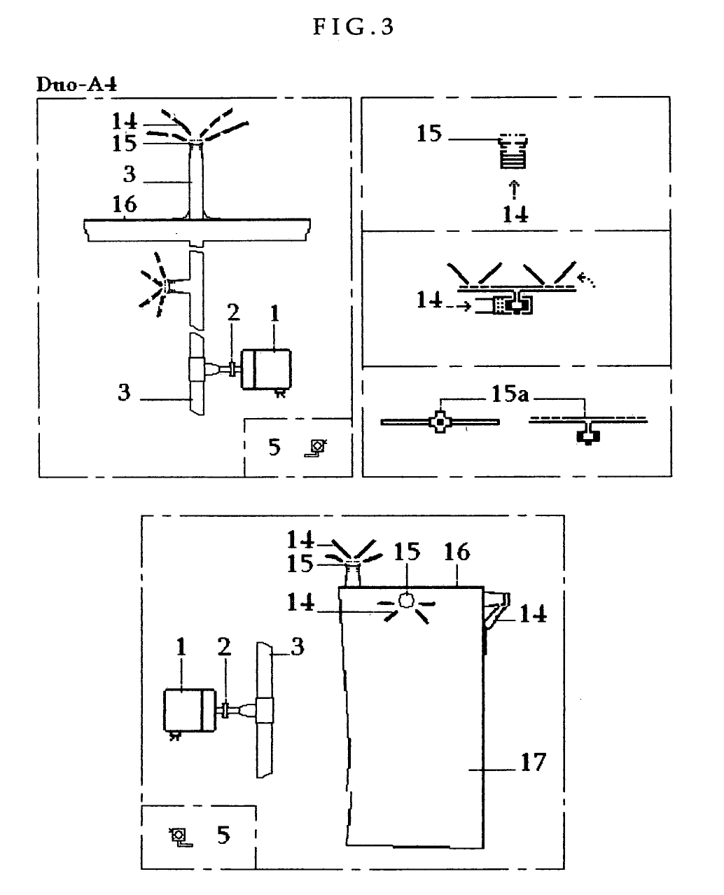

FIG. 3; Duo-A4 Automatic reacting by thermostat for anti-fire: detecting function on heat; thermostat 5, sensor or equivalent is connected motor 1 to turn faucet 2 on either pipe 3 watering or fire extinguisher spraying anti-fire chemicals against fire based detected result on thermostat, device(s) is installed everywhere as desirable in airplanes, ships, all motor & engine vehicles, transportations, houses, buildings 17 and constructions, etc, where we install pipes 3 with sprays 15 or rotating spray 15a devices bringing water 14 to roofs 16 and highest top outer walls where central valve(s) of pipes watering installed for fire prevention in saving human lives and material damages in case on fire, fire alarm may be connected with device.

Duo-A2 Automatic reacting by central valve with/without motor: simple action is to turn central valve(s) linked pipe network to water all spraying outlets installed everywhere in and around fields of trees, farm, forest, grassland, etc replacing manual watering process one after another to entire fields, a timer is added for motor rotating valve with switch or sensor.

FIG. 1; Duo-A2a Automatic reacting by central faucet 2a of spraying powder device 6 with/without motor: it has container 7 for dropping (small) seeds, (hot pepper) farming powder 9, liquid therein, its lower outlet with a disk 8 is rotated by equipped motor 1 with switch or sensor opening or closing to let seeds or powder falling into pipes mixing up with water flowing having central faucet(s) to all outlets everywhere in the farming land.

FIG. 2; Duo-A3 Automatic reacting by switch of motor changing oil device: engine 10 oil bolt 12 is made inner pipe in holes with gear head linking to gear 13 of motor axis screwing out for changing oil 11 rotated by installed motor 1, motor has double spins, on-off at point, button switch 19 or hidden sensor is connected placing at easy reaching area for vehicle of engine, motor, all transportations, using vehicle electricity or pumping air.

Duo-A3a Automatic reacting by motor of motor rotating jack: rotating bolt of a jack is made either with gear head linking to gear of motor axis or jack bolt linked to motor axis rotated by installed motor to lift a vehicle using car electricity or drill of air pumping. Screwing or unscrewing tire bolts is by drill of air pumping connected to vehicle.

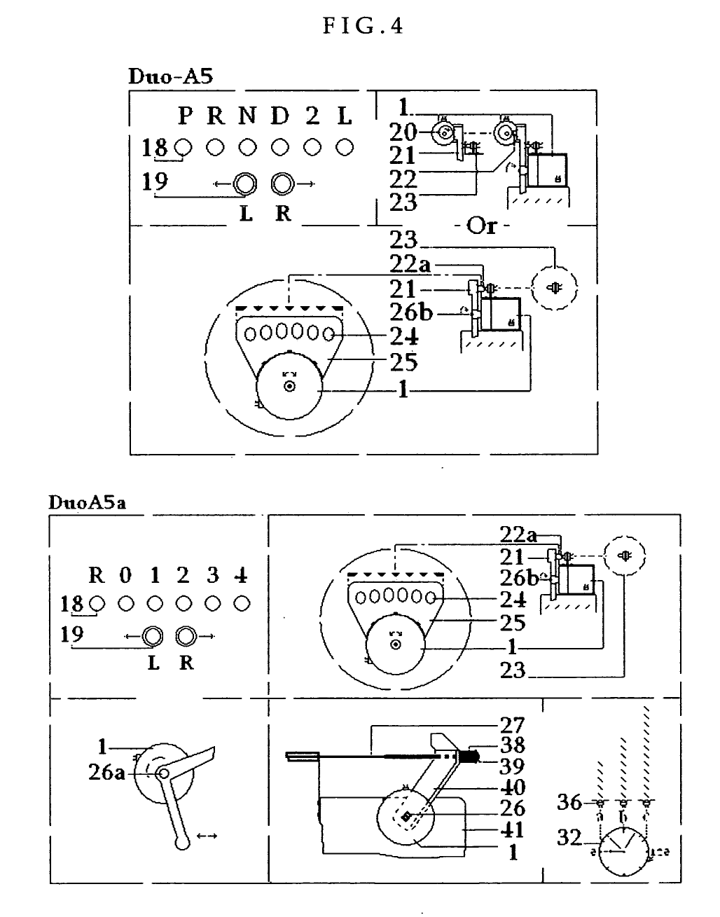

FIG. 4; Duo-A5 Auto pointing transmission: button switch or reacting sensor on, driver's “L” and “R” button switches 19 are for changing transmission speed commanding: (1) a mini-motor 1 is connected and fixed on transmission handle 21, motor axis is equipped at nearby edge part of an appropriate round wheel 20 rotating to press spring button 22 of handle, reverting by rewind spring for moving handle, (2) a double rotating motor 1 is equipped rotating its axis 26b with (hidden) transmission handle forward or backward, stopping at point, switches for turning motor off are installed at limit end of spin, (3) a spring lock 22a is fixed lower handle for entering into each positioning hole 24 of a metal sheet 25 to press separate switch 23 installed behind one's hole to turn respective lamp 18 on showing up the standing position of transmission speed to driver for vehicle of engine, motor, all transportations, (4) Structure of spring lock 22a is made bigger without using mini-motor, either clutch pedal is applied deeply by driver pressing switch/reacting sensor of system on or clutch pedal axis is rotated by a motor to disengage the clutch, releasing slowly by spring oil seal to motor axis for changing non automatic transmission of motor vehicle, transportations on using vehicle electricity or pumping air.

FIG. 4; Duo-A5a Automatic reacting of accelerator for non automatic transmission: switch or sensor nearby connecting to turn automatic accelerator on (or off), driver's “L” and “R” button switches 19 are for changing transmission speed commanding: (1) speedometer is connected and managed by each specific speed for changing speed no. 1 2 3 4 or 5 & R, reverting in order, (2) clutch pedal axis 26a is connected rotating by a motor 1 to disengage the clutch, releasing slowly by spring oil seal(s) gripping motor axis while (car) speed is reduced by mini motor 1 connected to speedometer and fixed rotating carburetor 41 bracket axis 26 accelerating or lowering speed, carburetor cable 27 ends through bracket 40, spring 38, cable bolt 39, (3) a double rotating motor 1 is connected and equipped its axis 26b with (hidden) transmission handle 21 rotating forward or backward stopping at point, switches for turning motor off are installed at limit end of spin, (4) spring lock 22a is fixed lower handle for entering into each positioning hole 24 of a metal sheet 25 to press separate switch 23 installed behind one's hole to turn respective lamp 18 on showing up the standing position of transmission speed to driver, (5) speed will be switched reducing by connected signal lamp on before turning, each front radar or sensor 36 detects proper distance to react its own specified speed on speedometer 32 to rotate double spin motor for accelerating speed on running or for lowering speed against obstruction based detected result on radars including front radars “a, b, c” and so on as written in Duo-A8.

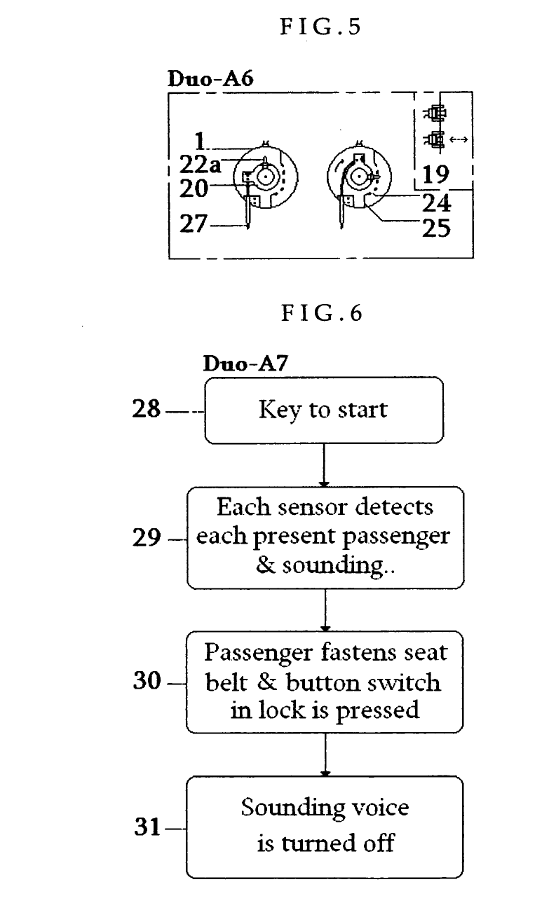

FIG. 5; Duo-A6 Automatic reacting of emergency (hand) brake: double rotating motor 1 is connected and equipped for (hidden) emergency brake, its axis possesses a wheel 20 fixed with cable 27 rotating to draw for applying rear or all wheel brakes on braking or releasing pressed by button switch 19 or reacting sensor, brake is locked by lock device 22a of wheel into hole(s) 24 on metal sheet 25 at motor replacing manual braking for engine, motor vehicles, all transportations. If motor with rewind spring is used, a mini-motor is added to draw or push lock device, using vehicle electricity or pumping air.

FIG. 6; Duo-A7 Automatic reacting by sensor for seat belt: key to start 28, individual sensor is connected and installed at vehicle door or elsewhere for detecting each present passenger in vehicle 29, device sounding sonorous signal lamp or speaking recorded message and showing “unlocked” design on screen based on detected result, it stops sounding 31 until passenger(s) fastens seat belt(s) by pressing off button switch installed in seat belt lock(s) 30 for engine, motor vehicles, all transportations.

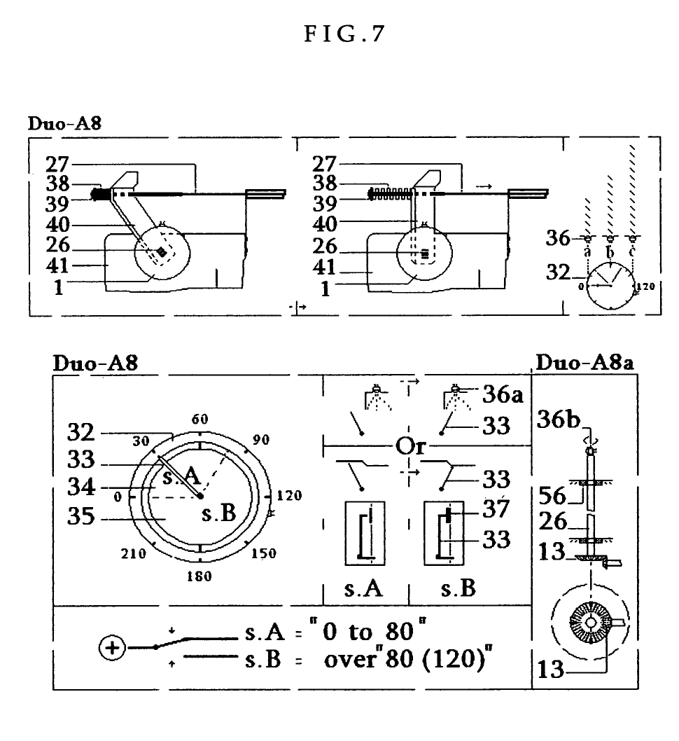

FIG. 7; Duo-A8 Automatic reacting of accelerator: either switch or sensor nearby accelerator connecting to turn automatic accelerator device on or off, (1) a mini motor 1 is connected and fixed at carburetor 41 rotating carburetor bracket axis 26 to accelerate speed on vehicle running, carburetor cable 27 ends through bracket 40, spring 38, cable bolt 39, (2) speedometer is managed by each specific speed, speedometer is electrically connected by either speedometer pointer 33 conducting to indicator front/rear surface 37 or pointer reacting by sensor 36a connected mini motor to turn motor off springing bracket back by rewind spring for lowering car speed commanded by radar based detected result against obstruction that (3) each front radar/sensor 36 detects proper distance to react its own specified speed on speedometer 32 in which the third front radar “c” is for detecting at long specified distance connected speedometer at high speed, second front radar “b” is for detecting at middle specified distance connected speedometer at medium speed, first front radar “a” is for detecting at short specified distance connected speedometer at low speed, extra radar(s) if desirable. (4) Speedometer 32 is connected beyond specific speed 35 (s. B) at law limit 34 (s. A), device sounds or speaks recorded “warning” message to driver for vehicle of engine, motor, all transportations, using vehicle electricity or pumping air.

FIG. 7; Duo-A8a Automatic rotating of radar 36b or sensor in automatic braking device for vehicle of motor, engine, all transportations: front radar(s) is equipped linking gear 13 and axis 26 through bearings 56 with gear 13 of steering wheel or its linking division in which radar(s) has capability for turning right or left accorded with steering wheel under appropriate adjustment so as to avert function of automatic braking device against opposite vehicle during turning. Radar(s) will react to the speed of vehicle, all transportations on connected speedometer based detected result on a distance from vehicle to obstacle so as to primarily lower speed by automatic accelerator device depending the degree of speed, progressively to apply automatic braking averting possible collision, which is defined by a testing table of braking distance on speed in all vehicles.

Duo-A9 Automatic showing of horizontal level in all transportations: horizontal level indicators are installed both at crossing and straight positions for verifying well balancing of one's vehicle, status of tires, shock absorbers, supporting spring force etc in normal condition of driving for engine, motor vehicles, all transportations.

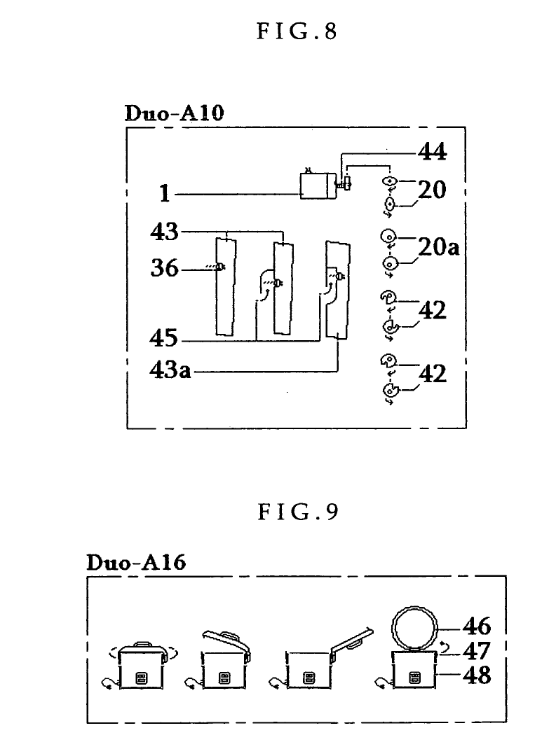

FIG. 8; Duo-A10 Automatic reacting by sensor including reacting proximate or touch sensor for opening door, mail box (closing by rewind spring): sensor 36 is connected mini-motor 1 or equivalent with appropriate round wheel 20a or lock wheel 42 being fixed axis at its edge part nearby rotating to unlock door device for opening or pushing effect depending on its positioning and reverting by rewind spring 44 for opening doors 43 of appliances, door of microwave, door of oven, door of refrigerator, door of dish washer, door of washing machine, door of furniture, doors 43a of car, door of mail box, etc, opening is by reacting 45 proximate sensor replacing hand opening.

Duo-A11 Automatic reacting by sensors in keys including reacting proximate or touch sensors: keys are made of sensors in keyboard of computer PC, sensors in keyboard of laptop, sensors in keyboard of word-processor, sensors in keyboard of typewriter, etc except two keys with convex surfaces “F” and “J” of keyboard & no. 5 on figures remaining unchanged referring to key installation as standing finger points for accelerating key processing speed, keying is by reacting proximate or touch sensor keys connected and installed in place of manual buttons.

Duo-A12 Automatic reacting by sensors including reacting proximate or touch sensors as switches and button switches: reacting either proximate or touch sensors are connected and installed as electric buttons in all kinds of appliances, in instruments, in equipments, in machineries; finger buttons replaced by sensors in telephones, in cell phones and in facsimile machines, keys replaced by sensors in pianos, buttons replaced by sensors in calculators, in computer PCs, in laptops, in televisions, in cash machines, in copiers, in scanners, in printers, in microwaves, in cookers, in ovens, in blenders, in air conditioners, in fans, in radiators, in music instruments, in videocassette & disk recorders, in DVD players, in radios, in cassettes, in stereos, and in game boys, etc, all electric buttons including starting key replaced by sensors inside vehicles, transportations, etc for accelerating speed in place of finger buttons.

Duo-A13 Automatic reacting by sensors including reacting proximate or touch sensors as buttons: mini-motor with oval wheel 20 (FIG. 8), battery is connected and installed rotating to press button in camera, video camera for photographing steadier reacting by either proximate or touch sensor in place of manual button which causes movement in making photo unclear.

Duo-A14 Automatic reacting by sensor including reacting proximate sensor for bell, electric lift, etc: sensor is fixed outdoor of house, building, construction, etc connected bell sounding by reacting proximate sensor, sensor(s) is connected and installed at starting area for reacting function of electric lift, electric belting conveyor, etc with sufficient time sending people to terminal and stopping.

Touch sensor; touch sensor should be made with thin and soft covered sheet to avert that its beam touches human fingers for healthy precaution.

Duo-A15 Automatic stove timer: either manual rotating timer or electronic numbering timer is connected and equipped at gas stove, electrical stove for setting time of cooking, heating buttons remain unchanged.

FIG. 9; Duo-A16 Auto-moving cover of cooker including cover of rice-cooker: cover 46 is made at its separate unit 47 to be locked by closing, its unit is encircled on the (ball) rail in groove part of cooker body 48, cover is opened at right hand side by pushing to the center facilitating to take rice out of cooker with one's right hand.

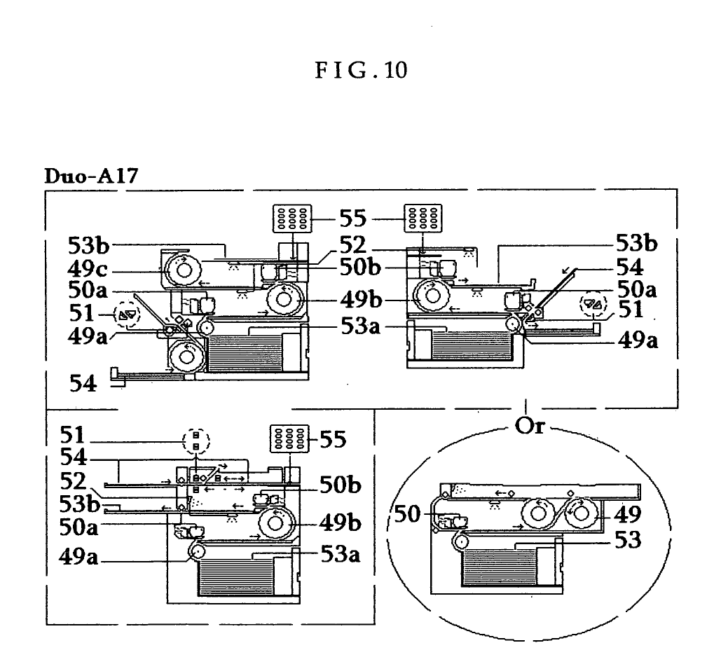

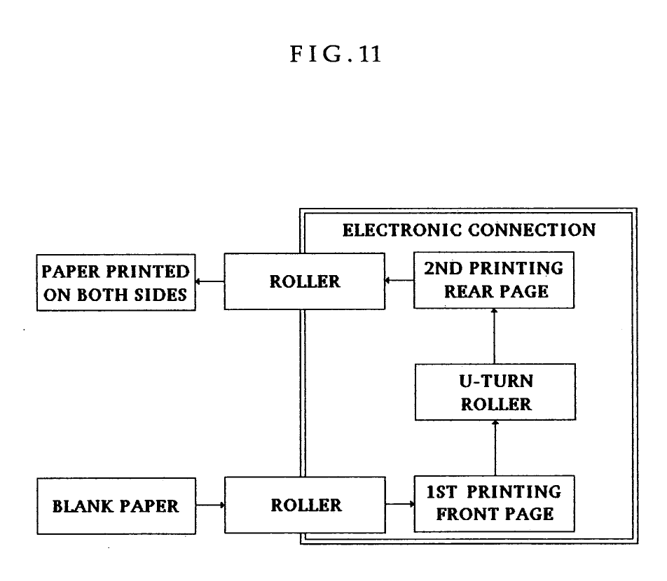

FIG. 10; Duo-A17 Automatic processing is for transmission, reception, copying, scanning and printing on both sides of document 54 and paper in facsimile machines, copiers, scanners and printers; two scanning devices 51 are connected and installed one against the other moving or letting document pass through. Paper passes two printing units or two times at one printing unit 50 printing on both sides of paper and roller 49 is for rotating two sides, roller(s) 49a is installed moving blank paper 53a or 53 from drawer to the first printing unit 50a equipped for printing front page, paper is then U-turned by second roller(s) 49b for installed second unit 50b printing on its reverse side, paper 53b will be rotated out by installed third roller(s) 49c at end process. Electronic connection, fans 52, sensor buttons 55, necessary parts are for setting to function. FIG. 11; Process of printing paper on both sides.

What I claim as my invention is:

1. Automatic reacting by thermostats, video cameras, radars, all kinds of sensors including reacting proximate sensors, touch sensors with/without thin & soft covered sheets, sensor keys, sensor buttons, speedometers, motors, switches, timers and/or any other equivalents, including:
Duo-A1 automatic reacting by thermostat for cutting off gas: detecting function on cooling; thermostat, sensor or equivalent connected and installed nearby flame of gas heating, gas stove, etc, connected motor turning gas valve to cut-off position based detected result on thermostat to stop gas spreading dangerously whenever gas flame blown off by accident, system functioning while rotating gas button in use,
Duo-A1a Automatic reacting by thermostat switching on or off for air conditioner: thermostat or equivalent connected and installed either in air conditioner or in air conditioning inside area for switching air conditioner off whenever temperature being high or for switching it on whenever temperature dropping below based desirable temperature being switched, including installation of thermostat in air conditioner for engine, motor vehicles, all transportations to that function,
Duo-A4 automatic reacting by thermostat for anti-fire: detecting function on heat; thermostat, sensor or equivalent connected motor to turn faucet on either pipe watering or fire extinguisher spraying anti-fire chemicals against fire based detected result on thermostat, device(s) be installed everywhere as desirable for airplanes, ships, all motor & engine vehicles, transportations, houses, buildings and constructions, etc, where central valve of pipes for watering installed for fire prevention, fire alarm be connected with device,
Duo-A2 automatic reacting by central valve with/without motor: simple action to turn central valve(s) linked pipe network to water all spraying outlets installed everywhere in and around fields of trees, farm, forest, grassland, etc to replace manual watering process one after another to entire fields, a timer added for motor rotating valve with switch or sensor,
Duo-A2a automatic reacting by central valve of spraying powder device: spraying powder device having container for dropping seeds or powder therein, its lower outlet with a disk rotated by equipped motor with switch or reacting sensor opening or closing to let seeds or powder falling into flowing water pipes having central faucet(s) to all outlets everywhere in farming land,
Duo-A3 automatic reacting by switch of motor changing oil device: engine oil bolt made inner pipe in holes with gear head linking to gear of motor axis screwing out for changing oil rotated by installed motor, motor having double spins, on-off at point, connected button switch or hidden reacting sensor placing at easy reaching area for engine, motor vehicles, all transportations, using vehicle electricity or pumping air,
Duo-A3a automatic reacting by motor of motor rotating jack: rotating bolt of jack made either with gear head linking to gear of motor axis or jack bolt linked to motor axis rotated by installed motor for elevating a vehicle using car electricity or drill of air pumping, screwing or unscrewing tire bolts by drill of air pumping connected to vehicle,
Duo-A5 Auto pointing transmission: button switch or reacting sensor on, driver's “L” and “R” button switches being connected for changing transmission speed commanding: (1) a mini-motor connected and fixed on transmission handle, motor axis equipped at nearby edge part of an appropriate round wheel rotating to press spring button of handle, reverting by rewind spring for moving handle, (2) a double rotating motor connected and equipped rotating its axis with (hidden) transmission handle forward or backward, stopping at point, switches for turning motor off installed at limit end of spin, (3) a spring lock fixed lower handle for entering into each positioning hole of a metal sheet to press separate switch connected and fixed behind one's hole to turn respective lamp on showing up the standing position of transmission speed to driver for vehicle of engine, motor, all transportations, (4) Structure of spring lock be made bigger without using mini-motor, either clutch pedal applied deeply by driver pressing switch/reacting sensor of system on or clutch pedal axis rotated by a motor to disengage the clutch, releasing slowly by spring oil seal to motor axis for changing non automatic transmission of engine, motor vehicles, transportations on using vehicle electricity or pumping air,
Duo-A5a Automatic reacting of accelerator for non automatic transmission: switch or sensor nearby connecting to turn automatic accelerator on (or off), driver's “L” and “R” button switches connected and installed for changing transmission speed commanding: (1) speedometer connected and managed by each specific speed for changing speed no. 1 2 3 4 or 5 & R, reverting in order, (2) clutch pedal axis connected rotating by a motor to disengage the clutch, releasing slowly by spring oil seal(s) gripping motor axis while (car) speed reduced by mini motor connected to speedometer and fixed rotating carburetor bracket axis accelerating or lowering speed, carburetor cable ending through bracket, spring, cable bolt, (3) a double rotating motor connected and equipped its axis with (hidden) transmission handle rotating forward or backward stopping at point, switches for turning motor off installed at limit end of spin, (4) spring lock fixed lower handle for entering into each positioning hole of a metal sheet to press separate switch connected and installed behind one's hole to turn respective lamp on showing up the standing position of transmission speed to driver, (5) speed switched reducing by connected signal lamp on before turning, each front radar or sensor detecting proper distance to react its own specified speed on speedometer to rotate double spin motor for accelerating speed on running pr for lowering speed against obstruction based detected result on radars including front radars “a, b, c” and so on as written in Duo-A8,
Duo-A6 automatic reacting of emergency (hand) brake: double rotating motor connected and equipped for (hidden) emergency brake, its axis possessing a wheel fixed with cable rotating to draw for applying rear or all wheel brakes on braking or releasing pressed by connected button switch or sensor, brake locked by lock device of wheel into hole(s) on metal sheet at installed motor to replace manual brake for engine, motor vehicles, all transportations, if motor with rewind spring be used, a mini-motor added to draw or push lock device, using vehicle electricity or pumping air,
Duo-A7 automatic reacting by sensor for seat belt: key to start, individual sensor connected and installed at vehicle door or elsewhere for detecting each present passenger in vehicle, connected device sounding or speaking recorded message and showing “unlocked” design on screen based on detected result, stopping sounding until passenger(s) fastening seat belt(s) by pressing off button switch installed in seat belt lock(s) for engine, motor vehicles, all transportations,
Duo-A8 Automatic reacting of accelerator: either switch or sensor nearby accelerator connecting to turn automatic accelerator device on or off, (1) a mini motor being connected and fixed at carburetor rotating carburetor bracket axis to accelerate speed on vehicle running, carburetor cable ending through bracket, spring, cable bolt, (2) speedometer managed by each specific speed; speedometer connected electrically by either speedometer pointer conducting to indicator front/rear surface or pointer reacting by sensor connected mini motor to turn motor off springing bracket back by rewind spring for lowering car speed commanded by radar based detected result against obstruction that (3) each front radar or sensor detecting proper distance to react its own specified speed on speedometer in which the third front radar “c” for detecting at long specified distance connected speedometer at high speed, second front radar “b” for detecting at middle specified distance connected speedometer at medium speed, first front radar “a” for detecting at short specified distance connected speedometer at low speed, extra radar(s) if desirable. (4) speedometer connected beyond specific speed at law limit, device sounding or speaking recorded “warning” message to driver for engine, motor vehicles, all transportations, using vehicle electricity or pumping air,
Duo-A8a Automatic rotating of radar or sensor in automatic braking device for vehicle of motor, engine, all transportations: front radar(s) being equipped linking gear and axis through bearings with gear of steering wheel or its linking division in which radar(s) having capability for turning right or left accorded with steering wheel under appropriate adjustment so as to avert function of automatic braking device against opposite vehicle during turning, radar(s) reacting to the speed of motor vehicle, all transportations on connected speedometer based detected result on a distance from vehicle to obstacle so as to primarily lower speed by automatic accelerator device depending the degree of speed, progressively to apply automatic braking averting possible collision, which defined by a testing table of braking distance on speed in all vehicles,
Duo-A9 automatic showing of horizontal level: horizontal level indicators being installed both at crossing and straight positions for verifying well balancing of one's vehicle, status of tires, shock absorbers, supporting spring force etc in good condition of driving for vehicle of engine, motor, all transportations,
Duo-A10 automatic reacting by sensor including reacting proximate or touch sensor for opening door, mail box (closing by rewind spring): sensor connected mini-motor or equivalent with oval wheel or lock wheel being fixed axis rotating to unlock door device for opening or pushing effect depending on its positioning and reverting by rewind spring for opening doors of appliances, door of microwave, door of oven, door of refrigerator, door of dish washer, door of washing machine, door of furniture, doors of car, door of mail box, etc, opening is by reacting proximate sensor to replace hand opening,
Duo-A11 automatic reacting by sensors in keys including reacting proximate or touch sensors: keys made of sensors in keyboard of computer PC, sensors in keyboard of laptop, sensors in keyboard of word-processor, sensors in keyboard of typewriter, etc except two keys with convex surfaces “F” and “J” of keyboard & no. 5 on figures remaining unchanged referring to key installation as standing finger points for accelerating key processing speed, keying by reacting proximate or touch sensor keys being connected and installed in place of manual buttons,
Duo-A12 automatic reacting by sensors including reacting proximate or touch sensors as switches and button switches: reacting either proximate or touch sensors being connected and installed as electric buttons in all kinds of appliances, in instruments, in equipments, in machineries; finger buttons replaced by sensors in telephones, in cell phones and in facsimile machines, keys replaced by sensors in pianos, buttons replaced by sensors in calculators, in computer PCs, in laptops, in televisions, in cash machines, in copiers, in scanners, in printers, in microwaves, in cookers, in ovens, in blenders, in air conditioners, in fans, in radiators, in music instruments, in videocassette & disk recorders, in DVD players, in radios, in cassettes, in stereos, and in game boys, etc, all electric buttons including starting key replaced by sensors inside motor vehicles, all transportations, etc for accelerating speed in place of finger buttons,
Duo-A13 automatic reacting by sensors including reacting proximate or touch sensors as buttons: mini-motor with oval wheel, battery being connected and installed rotating to press button in camera, video camera for photographing steadier reacting by either proximate or touch sensor in place of manual button,
Duo-A14 automatic reacting by sensors including reacting proximate sensors for bell, electric lift, etc: sensor being fixed outdoor of house, building, construction, etc connected bell for sounding by reacting sensor, sensor(s) being connected and installed at starting area for reacting function of electric lift, electric belting conveyor, etc with sufficient time sending people to terminal and stopping,
Duo-A15 automatic stove timer: either manual rotating timer or electronic numbering timer being connected and equipped at gas stove, electric stove for setting time of cooking, heating buttons remain unchanged,
Duo-A16 auto-moving cover: cover made at its separate unit to be locked by closing, its unit encircling on the (ball) rail in groove part of cooker body, opening cover at right hand side by pushing to the center facilitating to take rice out of cooker.

2. Automatic processing for transmission, reception, copying, scanning and printing on both sides of document and paper for facsimile machines, copiers, scanners and printers wherein two scanning devices being connected and installed one against the other moving or letting document pass through, paper passing two printing units or two times at one printing unit printing on both sides of paper, certain roller rotating two sides, installed roller(s) moving blank paper from drawer to the first printing unit equipped for printing front page then paper being U-turned by second roller(s) for installed second unit printing on its reverse side, paper being rotated out by installed third roller(s) at end process, electronic connection, extra fans, extra rollers, sensor buttons, necessary parts setting to function.

3. Automatic reacting by thermostats, video cameras, radars, all kinds of sensors including reacting proximate sensors, touch sensors with/without thin & soft covered sheets, sensor keys, sensor buttons, speedometers, motors, switches, timers and/or any other equivalents referring to claim 1 and Automatic processing for transmission, reception, copying, scanning and printing on both sides of document and paper for facsimile machines, copiers, scanners and printers referring to claim 2 wherein the original elements, composition, connection, operation, function, structures, illustrations, process of making, production, installation, necessary parts, functioning including energy of all sorts, combination, extension and using of the invention, any other structures, modifications, facilities, imitations, substitutes, replacement of parts being assembled for performing both the same and similar formation referring to fundamentals of the invention in these documents functioning to the same effect, combining the invention with any other objects, machineries, instruments, equipments, appliances, telephones, computers, devices, structures, systems, projects, etc functioning to the same and/or similar outcome using same or other names are in the scope of protection of the invention, the invention used for all transportations; engine, motor vehicles, automobiles, cars, trucks, buses, vans, trains, trolleys, underground trains, tanks, motorcycles, airplanes, ships, submarines, helicopters, space rockets, missiles, fleet, tractors, cultivators, generators, pumps, compressors, machineries, equipments, appliances, moving objects of all sorts, all areas, fields, and everywhere.
